(19) United States
(12) Patent Application Publication
(10) Pub. No.: US 2017/0358042 A1
(43) Pub. Date: Dec. 14, 2017

(54) CUSTOMER MANAGEMENT SYSTEM, CUSTOMER MANAGEMENT METHOD, AND CUSTOMER MANAGEMENT PROGRAM

(71) Applicant: TOSHIBA TEC KABUSHIKI KAISHA, Tokyo (JP)

(72) Inventor: Katsuya Sasahara, Izu Shizuoka (JP)

(21) Appl. No.: 15/688,997

(22) Filed: Aug. 29, 2017

Related U.S. Application Data
(62) Division of application No. 14/799,880, filed on Jul. 15, 2015.

(51) Int. Cl. G06Q 50/12; G06Q 30/06; G06Q 10/06

(52) U.S. Cl. CPC G06Q 50/12; G06Q 10/063; G06Q 30/06

(57) ABSTRACT

According to one embodiment, a customer management system includes an identification-information acquiring unit, a stage determining unit, a contents selecting unit, and a distributing unit. The identification-information acquiring unit acquires identification information of a customer. The stage determining unit determines to which stage among a series of plurality of stages, which sequentially shift, the customer corresponding to the identification information belongs. The contents selecting unit selects, according to the stage determined by the stage determining unit, contents presented to the customer belonging to the stage. The distributing unit distributes the contents selected by the contents selecting unit to a terminal associated with the identification information of the customer.

### CROSS-REFERENCE TO RELATED APPLICATIONS

This application is a Division of application Ser. No. 14/799,880 filed Jul. 15, 2015, the entire contents of which are incorporated herein by reference.

### FIELD

Embodiments described herein relate generally to a customer management technique that can contribute to improvement of convenience for customers who are waiting for their turns.

### BACKGROUND

In a store such as a restaurant where customers wait for their turns until they can take seats, a turn waiting management system has been sometimes introduced separately from an order system.

Such a turn waiting management system has, for example, a function of managing the order of turn waiting of the customers and notifying the customers that their turns come.

However, in the turn waiting management system, the customers cannot effectively use time during the turn waiting and are likely to get bored.

### DESCRIPTION OF THE DRAWINGS

FIG. 1 is a system configuration diagram for explaining a customer management system;

FIG. 2 is a functional block diagram for explaining the customer management system;

FIG. 3 is a diagram showing an example of a management table;

FIG. 4 is a flowchart for explaining a flow of processing in the customer management system; and

FIG. 5 is a diagram showing an example of a display screen of a tablet terminal on which contents distributed by a CPU (a distributing unit) can be browsed.

### DETAILED DESCRIPTION

An embodiment is explained below with reference to the drawings.

### System Configuration

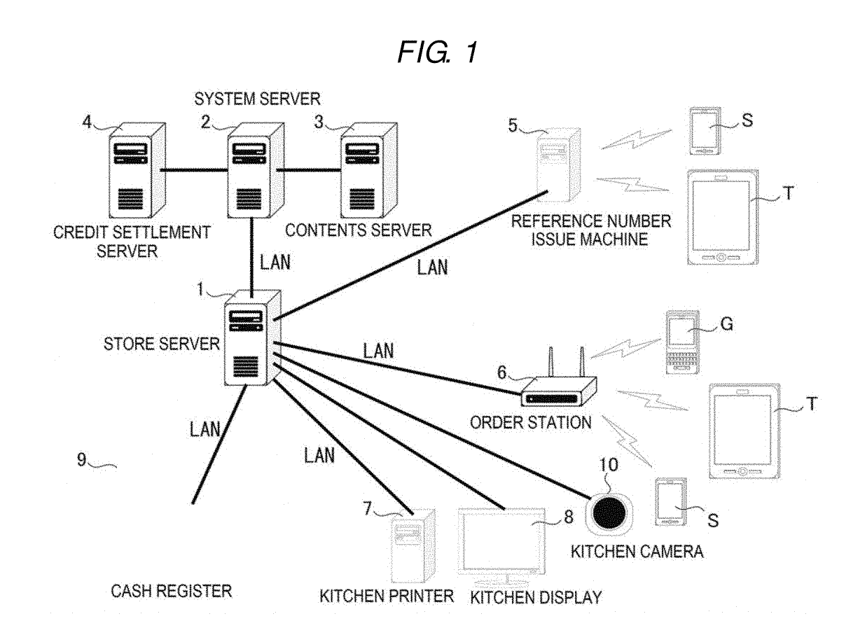

FIG. 1 is a system configuration diagram for explaining a customer management system.

The customer management system according to an embodiment includes, for example, a store server 1, a system server 2, a contents server 3, a credit settlement server 4, a reference number issue machine 5, an order station 6, a kitchen printer 7, a kitchen display 8, a cash register 9, a kitchen camera 10, smart phones S, tablet terminals T, and handy terminals G.

The reference number issue machine 5, the order station 6, the kitchen printer 7, the kitchen display 8, the cash register 9, and the kitchen camera 10 are mutually communicably connected to the store server 1 through an electric communication line such as a LAN (Local Area Network).

The store server 1 is mutually communicably connected to the system server 2 through an electric communication line such as a LAN or the Internet. The store server 1 is capable communicating with the contents server 3 and the credit settlement server 4 via the system server 2.

For example, it is assumed that the store server 1, the reference number issue machine 5, the order station 6, the kitchen printer 7, the kitchen display 8, the cash register 9, and the kitchen camera 10 are set in a restaurant. Note that the kitchen printer 7, the kitchen display 8, and the kitchen camera 10 are set in a kitchen.

Details of the apparatuses configuring the customer management system according to the embodiment are explained below.

The store server 1 collects information acquired by the apparatuses in the store, performs various arithmetic operations on the basis of the collected information, and controls terminals (e.g., the reference number issue machine 5, the kitchen printer 7, and the kitchen display 8) having an image display function, a printing function, a sound output function, and the like.

The system server 2 has a function of managing exchange of information between the store server 1 and the contents server 3 and the credit settlement server 4.

The contents server 3 manages various contents such as music, movies, dramas, electronic books, and games provided to enable customers to browse the contents with the smart phones S and the tablet terminals T carried by the customers and the tablet terminals T and the like lent to the customers by the store.

The credit settlement server 4 provides a credit settlement processing function if the customers use credit cards for payment.

The reference number issue machine 5 is set near the entrance of the store and issues numbered tickets or presents reference numbers (identification numbers) to the customers visiting the store. Naturally, the reference number issue machine 5 can also electronically transmit the numbered tickets, the reference numbers, and the like to the smart phones S, the tablet terminals T, and the like carried by the customers.

The order station 6 has a role of communicating with the handy terminals G, which are dedicated terminals for order taking used in the store, and transmitting order information and the like received by the handy terminals G to the store server 1. The order station 6 can also receive orders from the smart phones S and the tablet terminals T installed with predetermined application software for menu ordering.

The kitchen printer 7 performs a print output of order slips for presenting the order information received by the order station 6 to staff members in the kitchen.

The kitchen display 8 performs screen display for presenting the order information received by the order station 6 to the staff members in the kitchen.

The cash register 9 performs accounting processing after meals of the customers. The cash register 9 has a function of receiving not only payment by cash but also payment by credit cards.

The kitchen camera 10 (an image pickup unit) is set in the kitchen and capable of picking up images of states during cooking.

The smart phones S are portable communication terminals carried by the customers.

The tablet terminals T may be portable communication terminals carried by the customers or may be communication terminals lent by the store and usable by the customers in the store.

### Functional Blocks

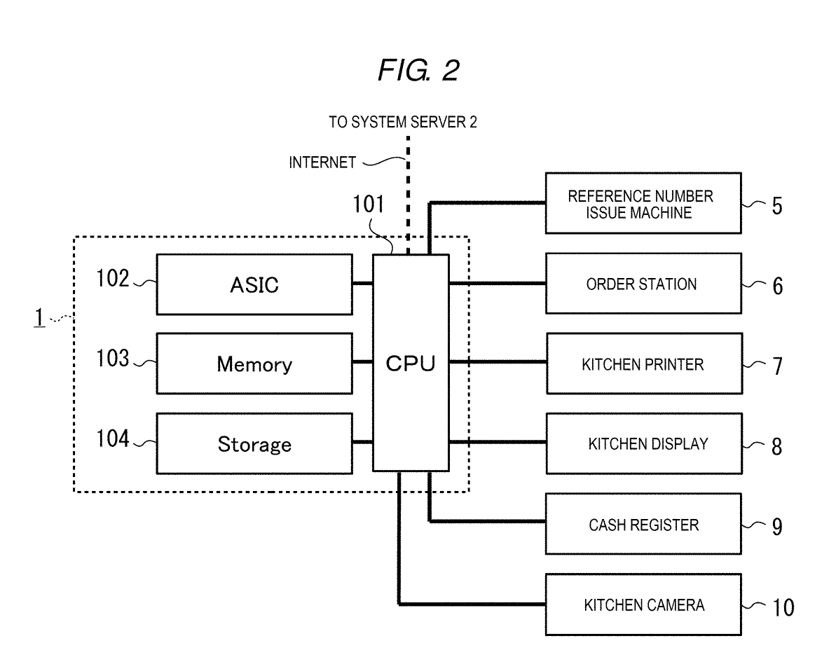

FIG. 2 is a functional block diagram for explaining the customer management system.

The store server 1 (a customer management apparatus) includes, for example, a CPU (a processor) 101, an ASIC (Application Specific Integrated Circuit) 102, a memory 103, and a storage 104.

The reference number issue machine 5, the order station 6, the kitchen printer 7, the kitchen display 8, the cash register 9, and the kitchen camera 10 are connected to the CPU 101 via an electric communication line such as a USB line, a LAN line, or a Wi-fi.

In the customer management system according to this embodiment, the CPU 101 has a role of performing various kinds of processing in the customer management system and also has a role of executing computer programs stored in the memory 103, the storage 104, and the like to thereby realize various functions. Note that, in this embodiment, as an example, the processor is the CPU (Central Processing Unit). However, it goes without saying that the processor can be realized by an MPU (Micro Processing Unit) capable of executing equivalent arithmetic processing. Similarly, the storage 104 can be replaced with a storage device such as a HDD (Hard Disk Drive) or a flash memory.

The memory 103 can be configured from, for example, a RAM (Random Access Memory), a ROM (Read Only Memory), a DRAM (Dynamic Random Access Memory), an SRAM (Static Random Access Memory), a VRAM (Video RAM), or a flash memory. The memory 103 has a role of storing various kinds of information and computer programs used in the customer management system.

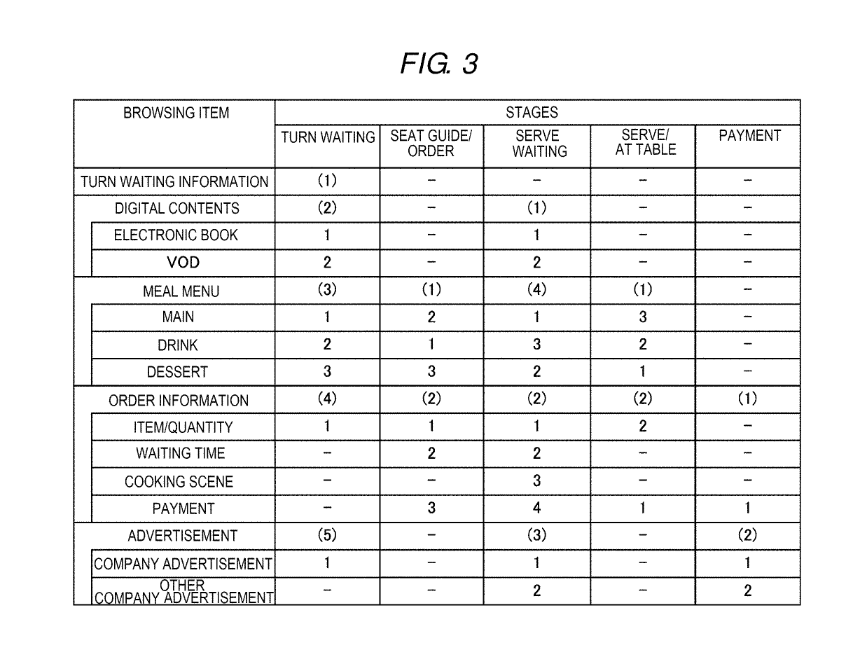

In the storage 104 of the store server 1, a management table shown in FIG. 3 is stored. Details of the management table are explained below. Naturally, the management table does not always need to be stored in the store server 1. The store server 1 may be stored in an external apparatus such as the system server 2 and referred to from the store server 1 according to necessity.

### Operation Explanation

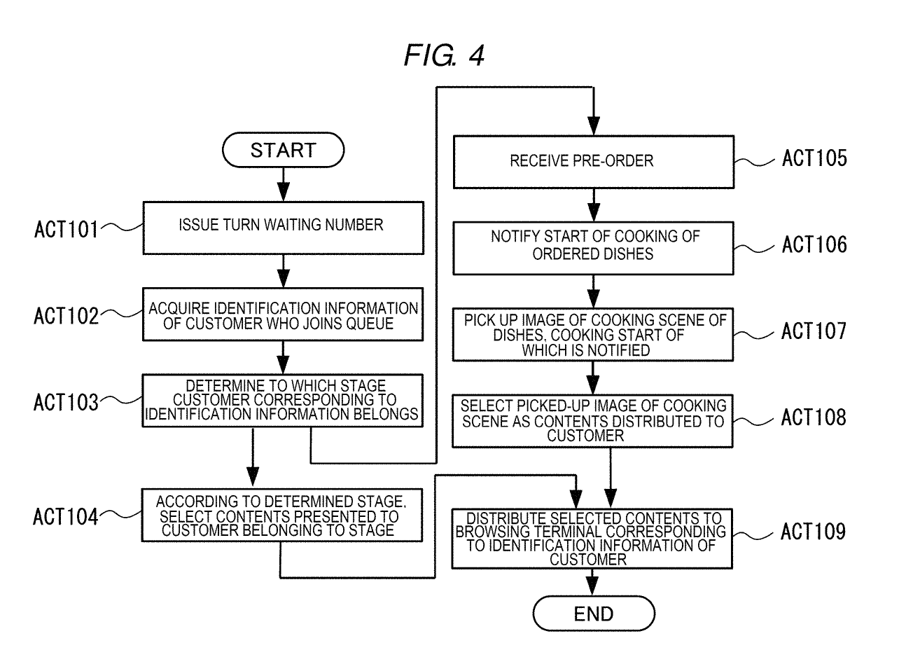

FIG. 4 is a flowchart for explaining a flow of processing in the customer management system.

First, when a customer arrives at the store, the customer operates the reference number issue machine 5 set near a store entrance and causes the reference number issue machine 5 to print a turn waiting slip on which a turn waiting number of the customer is written (ACT 101).

Subsequently, the customer scans the turn waiting number on the turn waiting slip with the smart phone S or the tablet terminal T carried by the customer and starts a web screen and predetermined application software exclusive for the store provided by the store server 1 to browse contents provided by the store. Naturally, instead of the scanning of the turn waiting slip by the smart phone S or the like, the customer may read, with the smart phone S or the like, “information indicating the turn waiting number” displayed on a screen of the reference number issue machine 5. The “information indicating the turn waiting number” may be the turn waiting number itself or may be barcode representation of the turn waiting number. Besides, as the acquisition of the turn waiting number by the smart phone S or the like, the turn waiting number may be received by radio communication means such as a Wi-Fi or a Bluetooth.

Note that it may be selected beforehand whether the turn waiting number slip is printed by the reference number issue machine 5. If it is selected not to print the turn waiting number slip, a point may be given (an eco point).

The CPU 101 (an identification-information acquiring unit) acquires, as identification information of a customer who joins a waiting queue, for example, a turn waiting number or a peculiar identification number of a communication terminal of the customer (ACT 102).

The CPU 101 (a stage determining unit) determines to which stage among a series of plurality of stages, which sequentially shift, the customer corresponding to the identification information belongs (ACT 103). The determination of the stage can be executed on the basis of, for example, content of an operation input to the communication terminal by the customer, position information of the communication terminal in the store, or stage information decided by an operation input by the customer himself or herself or a store staff member.

Specifically, examples of the “series of plurality of stages” include stages described below.

(1) Turn waiting

(2) Seat guiding

(3) Order receiving

(4) Dish service waiting

(5) Dish being served

(6) At table

(7) Paying

The CPU 101 (a contents selecting unit) selects, according to a stage determined by the CPU 101 (the stage determining unit), on the basis of the management table shown in FIG. 3, contents presented to customers belonging to the stage (ACT 104).

Specifically, the CPU 101 (the contents selecting unit) changes, according to the stage determined by the CPU 101 (the stage determining unit) , browsing possibility and possibility and priority order of display of various contents managed by the contents server 3.

Examples of specific browsing target contents include contents described below.

(1) Turn waiting information

(2) Digital contents

(3) Meal menu

(4) Order information (including payment)

(5) Advertisement

For example, as specified in the management table shown in FIG. 3, concerning customers belonging to the stages such as the “order receiving” and the “at table”, the CPU 101 (the contents selecting unit) does not include the “digital contents” in the browsing targets.

The CPU 101 (a pre-order receiving unit) receives, via the communication terminal such as the tablet terminal T, according to necessity, an order (a pre-order) from a customer waiting for his or her turn before being guided to a seat (ACT 105).

The pre-order determined during the turn waiting may be immediately notified to the order station 6 in the kitchen, for example, when the customer who made the pre-order is seated. As timing for notifying the kitchen of the pre-order, seating of the customer can be automatically determined on the basis of position information or the like of the tablet terminal T lent to the customer or the pre-order may be notified to the order station 6 in the kitchen by an operation input of the customer.

The CPU 101 (a notifying unit) notifies, on the basis of an operation input or the like indicating that cooking of dishes for which an order is received by the CPU 101 (the pre-order receiving unit) from the customer is started, the system to the effect that the cooking of the dishes is started (ACT 106).

The kitchen camera 10 (an image pickup unit) picks up an image of a cooking scene of the dishes, the cooking start of which is notified by the CPU 101 (the notifying unit) (ACT 107).

The CPU 101 (the contents selecting unit) selects, as contents that should be distributed to the customer who made the order of the dishes and belongs to the stage of the turn waiting, the image of the cooking scene picked up by the kitchen camera 10 (the image pickup unit) (ACT 108).

In this embodiment, as an example, the customer management system picks up the image of the actual cooking scene of the ordered dishes and enables the customer who ordered the dishes to browse the cooking scene. However, not only this, but the customer management system may enable the customer to browse, as contents, a cooking scene recorded beforehand or browse a still image.

When enabling the customer to browse the cooking scene, the customer management system may estimate a cooking completion time on the basis of an average cooking time and display the progress of the cooking as a progress bar.

The CPU 101 (the notifying unit) can determine the cooking start of the ordered dishes according to, for example, an operation input of a cook for notifying a cooking start of any dishes or an operation for holding a barcode or the like of a slip, on which ordered dish contents are written, over a camera functioning as the image pickup unit.

The CPU 101 (a distributing unit) distributes the contents selected by the contents selecting unit as explained above to a browsing terminal associated with identification information of the customer or enables the customer to browse the contents with browsing terminals (ACT 109).

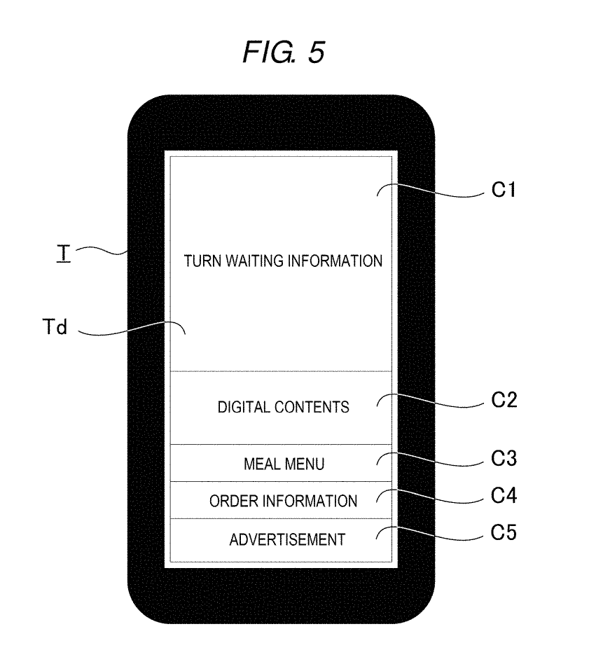

FIG. 5 is a diagram showing an example of a display screen of the tablet terminal T on which contents distributed by the CPU 101 (the distributing unit) can be browsed. For example, if a waiting state of a customer borrowing the tablet terminal T is the “turn waiting”, the CPU 101 (the distributing unit) arrays and displays, as shown in FIG. 5, “turn waiting information”, “digital contents”, “meal menu”, “order information”, and “advertisement” in this order from the top of on the display screen of the tablet terminal T on the basis of the management table shown in FIG. 3.

In FIG. 3, levels of display priority order of the contents to be browsed by the customer at the stage of the “turn waiting” are defined by a relation described below.

Turn waiting information>digital contents>meal menu>order information>advertisement

Therefore, as shown in FIG. 5, a display area of a display field of the turn waiting information is set to be the largest.

During payment after finishing the meal, the customer instructs settlement execution with, for example, the tablet terminal T lent by the store and performs closing processing with the tablet terminal T at hand to display a settlement code on the display screen of the tablet terminal T. When checking out, the customer causes the cash register 9 to scan the settlement code. Settlement processing is completed.

Note that the CPU 101 (a waiting-time predicting unit) can determine a predicted waiting time of the customer whose identification information is acquired by the CPU 101 (the identification-information acquiring unit) .

The “predicted waiting time of the customer” can be defined, for example, as described below.

(1) A predicted waiting time until the customer who joins the waiting queue and whose identification information is acquired by the identification-information acquiring unit is guided to a seat

(2) A predicted waiting time until the customer who joins the waiting queue and whose identification information is acquired by the identification-information acquiring unit starts an order

For the prediction of the waiting time in this embodiment, various publicly-known prediction algorithms executed on the basis of various kinds of information described below can be adopted.

(1) Statistical data in the past

(2) The number of customers currently waiting

(3) The number of customers currently at table

(4) Average cooking times of menu items

(5) Period of time

(6) Day of week

The CPU 101 (a cooking instructing unit) can instruct, on the basis of the “predicted waiting time” predicted by the CPU 101 (the waiting-time predicting unit) and “order content received by the pre-order receiving unit”, the start of cooking with the order content.

The operations in the processing in the customer management system are realized by causing the CPU 101 to execute a customer management program stored in the memory 103.

Further, a computer program for causing a computer configuring the customer management system to execute the operations can be presented as the customer management program. In this embodiment, as an example, the computer program for realizing the functions for carrying out the invention is recorded in advance in a storage region provided on the inside of the apparatus . However, not only this, but the same computer program may be downloaded to the apparatus from a network or the same computer program stored in a computer-readable recording medium may be installed in the apparatus. A form of the recording medium may be any form as long as the recording medium can store the computer program and can be read by the computer. Specifically, examples of the recording medium include internal storage devices mounted on the inside of the computer such as a ROM and a RAM, portable storage media such as a CD-ROM, a flexible disk, a DVD disk, a magneto-optical disk, and an IC card, a database that stores a computer program, other computers and databases of the computers, and a transmission medium on a line. Functions obtained by the installation or the download in advance in this way may be realized in cooperation with an OS (operating system) in the apparatus.

Note that a part of or the entire computer program may be a dynamically generated execution module.

It goes without saying that it is also possible to cause an ASIC to execute, in terms of a circuit, at least a part of the various kinds of processing realized by causing the processor to execute the computer program in the embodiments.

As explained above in detail, according to the technique described in this specification, it is possible to provide a customer management technique that can contribute to improvement of convenience for customers who join a waiting queue.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the sprit of the inventions. The accompanying claims and their equivalents are intended to cover such forms or modifications as would fall within the scope and spirit of the inventions.

What is claimed is:

1. A customer management system comprising:
a memory that stores executable components; and
a central processing unit, operatively coupled to the memory, that executes the executable components, the executable components comprising:
an identification-information acquiring unit configured to acquire identification information of a customer;
a stage determining unit configured to determine which stage, of a series of stages defined in management table data, is a current stage corresponding to the customer identified by the identification information, wherein the current stage sequentially shifts through the series of stages, and the series of stages comprises at least turn waiting, seat guiding, order receiving, dish service waiting, and at table;
a contents selecting unit configured to determine display priorities of respective browsing items based on priority data stored in the management table data, wherein the browsing items comprise at least turn waiting information, digital contents, meal menu information, and order information, and wherein the priority information defines different display priorities for the browsing items as a function of the current stage; and
a distributing unit configured to
send content of a subset of the browsing items corresponding to the current stage to a terminal device associated with the identification information of the customer,
send a subset of the display priorities corresponding to the subset of the browsing items to the terminal device, wherein based on the subset of the display priorities, the terminal device displays a first subset of the content corresponding to a browsing item, of the subset of the browsing items, having a highest display priority of the display priorities larger than a second subset of the content corresponding to other browsing items of the subset of the browsing items, and
in response to determining that the current stage is order receiving or at table, prevent the terminal device from displaying the digital contents.

2. The system according to claim 1, wherein the series of stages further includes at least one of dish being served or paying.

3. The system according to claim 2, further comprising:
a waiting-time predicting unit configured to determine a predicted waiting time of the customer associated with the identification information;
a pre-order receiving unit configured to receive, from the terminal device, order data specifying an order; and
a cooking instruction unit configured to instruct, based on the predicted waiting time predicted by the waiting-time predicting unit and the order data received by the pre-order receiving unit, a start of preparing the order.

4. The system according to claim 1, further comprising a pre-order receiving unit configured to receive, from the terminal device, order data specifying an order, wherein
in response to determining that the current stage is turn waiting, the contents selecting unit selects, as content to be sent to the terminal device, a cooking scene of one or more dishes corresponding to the order.

5. The system according to claim 1, further comprising:
a notifying unit configured to notify a preparation start of one or more dishes for which an order is received from the terminal device by the pre-order receiving unit; and
an image pickup unit configured to pick up an image of a cooking scene of the one or more dishes, wherein
in response to determining that the current stage is turn waiting, the contents selecting unit selects, as content to be sent to the terminal device, the image of the cooking scene picked up by the image pickup unit.

6. A customer management method, comprising:
acquiring, by a system comprising a processor, identification information of a customer;
determining, by the system, to which stage, a series of stages defined in management table data, is a current stage corresponding to the customer identified by the identification information, which wherein the current stage sequentially shifts through the series of stages, and the series of stages comprises at least turn waiting, seat guiding, order receiving, dish service waiting, and at table;
determining, by the system, display priorities of respective browsing items based on priority data stored in the management table data, wherein the browsing items comprise at least turn waiting information, digital contents, meal menu information, and order information;
sending, by the system, content of a subset of the browsing items corresponding to the current stage to a terminal device associated with the identification information of the customer;
sending, by the system, a subset of the display priorities corresponding to the subset of the browsing items to the terminal device, wherein based on the subset of the display priorities, the terminal device displays a first subset of the content corresponding to a browsing item, of the subset of the browsing items, having a highest display priority of the display priorities larger than a second subset of the content corresponding to other browsing items of the subset of the browsing items; and
in response to determining that the current stage is order receiving or at table, inhibiting, by the system, the terminal device from displaying the digital contents.

7. The method according to claim 6, wherein the series of stages further comprises at least one of dish being served or paying.

8. The method according to claim 7, further comprising:
determining a predicted waiting time of the customer associated with the identification information;
receiving, from the terminal device, order information specifying an order; and
instructing, based on the predicted waiting time and content of the order, a start of cooking with the order.

9. The method of claim 6, further comprising:
receiving, from the terminal device, order information specifying an order from; and
in response to determining that the current stage is turn waiting, selecting, as content for sending to the terminal device, a preparation scene of one or more dishes associated with the order.

10. The method according to claim 6, further comprising:
notifying a preparation start of one or more dishes associated with an order identified by order information received from the terminal device;
obtaining an image of a preparation scene of the one or more dishes; and
in response to determining that the current stage is turn waiting, selecting, as content for sending to the terminal device, the image of the preparation scene.
